(19) United States
(12) Patent Application Publication
(10) Pub. No.: US 2009/0024810 A1
(43) Pub. Date: Jan. 22, 2009

(54) Memory area management method

(75) Inventors: Daisuke Ito, Fuchu (JP); Shinji Fujiwara, Sagamihara (JP); Kazuo Otsuga, Kokubunji (JP); Shinya Kajiyama, Kodaira (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/219,051

(22) Filed: Jul. 15, 2008

(30) Foreign Application Priority Data
Jul. 19, 2007 (JP) 2007-188169
Jun. 20, 2008 (JP) 2008-161131

(51) Int. Cl. G06F 12/00

(52) U.S. Cl. 711/159; 711/E12.001

(57) ABSTRACT

In a storage device, a method is provided for preventing the risk of data loss and a significant decrease of writing speed due to area shrinkage when erased erase blocks have become fewer. A process of allocating a new page includes determining whether the length of a deallocated pages list is longer than n pages. If the list length is longer, one page is allocated from the deallocated pages list. If the list length is shorter, a capacity shortage error returns. Deleting a file using an erased pages list includes determining whether a page to be processed is emptied by deleting the file. If not so, the file is deleted from the page. If so, the contents of the last page-a in occupied pages are copied to the page, the page-a is written with data for erasure, and any erase block included in the page-a is made erasable.

### CLAIM OF PRIORITY

The present application claims priority from Japanese patent application JP 2007-188169 filed on Jul. 19, 2007, and JP 2008-161131 filed on Jun. 20, 2008, the contents of which are hereby incorporated by reference into this application.

The present invention relates to a data management technique for a storage device and, particularly, to an effective technique for data management using file system areas and database areas.

The present invention relates a method for managing file system areas and database areas on a storage device.

### BACKGROUND

As methods for efficiently managing data on storage devices such as, typically, e.g., hard disk drives, file system technologies and database technologies are known.

The file system technologies are those for handling large quantities of files which mostly have a size of several Kbytes or more. Structures for management called file system areas are created on a storage and the file system areas are manipulated via a file system processing unit that primarily operates as a part of an operating system. A system in which data is managed in terms of the file system areas by the file system processing unit is called a file system.

The database technologies are those for handling large quantities of records which mostly have a size on the order of several tens of bytes. Structures for management called database areas are created on a storage and the database areas are manipulated via a database management program that primarily operates on an operating system. A system in which data is managed in terms of the database areas by the database management program is called a database management system.

Further, hierarchization is often possible such that a database area is created in a file system area or, reversely, a file system area is created in a database area.

These file system technologies and database technologies have been developed, supposing that their operation applies to hard disk drives. Hard disk drives are characterized in that magnetic materials as memory elements are rewriteable a virtually infinite number of times.

Therefore, in the file system technologies and database technologies, metadata which is information for management throughout an area is fixed to an appropriate position such as the top or tail of the area and often overwritten repeatedly.

Meanwhile, in these years, replacing hard disk drives by silicon storages typified by nonvolatile semiconductor memories such as flash memories is ongoing.

For the nonvolatile semiconductor memories, their memory cells, minimum units of memory elements are rewritable up to about 10⁵ times which is smaller than hard disk drives. Hence, if they are used for storage application, it is necessary to perform management such as wear levelling 2001 (equalizing write counts) and bad erase block reallocation 2002 using a virtualization technique, which is shown in FIG. 12.

Meanwhile, data is generally protected by using parity and, hence, it does not happen that data once written fails to be read. To hold logical addresses for parity and wear levelling, these logical addresses for parity and wear levelling are stored on memory cells in addition to real data.

Nonvolatile semiconductor memories are difficult to handle, as the rewritable counts of memory cells are smaller than hard disk drives and usage on the assumption that a bad erase block exists or occurs is required. Accordingly, the use of memory cards, each configured with at least one nonvolatile semiconductor memory, has lately prevailed.

Here, erase blocks refer to minimum units that are erasable in a nonvolatile semiconductor memory. In the case of a nonvolatile semiconductor memory, a write operation per cell always takes place as transition from “1” to “0” and transition from “0” to “1” only takes place in an erase operation in units of erase blocks.

As the capacity of a nonvolatile semiconductor memory becomes larger and larger, the size of an erase block becomes larger, which is 128 Kbytes in a currently used NAND type flash memory.

A memory card generally consists of at least one nonvolatile semiconductor memory and a memory management unit which are packaged. The lifespan of a nonvolatile semiconductor memory (a rewritable count of about 10⁵) cannot be achieved without conforming to the parity bit length and the number of reserve erase blocks recommended by a memory vendor. However, these parameters differ from one vendor to another and one generation to another of a part supplied from even the same vendor.

Moreover, the model cycle of a nonvolatile semiconductor memory is one year, whereas that of a CPU (Central Processing Unit)/chip set is about two year. Accordingly, in order to continue to use a nonvolatile semiconductor memory for which the latest unit price of a bit throughout the model cycle of a final product is inexpensive, using a memory card is simple and effective.

In general, connectivity with an existing CPU and chip set is improved by emulating the I/O interface of general-purpose storage such as ROM (Read Only Memory) and USB (Universal Serial Bus) mass storage via the memory management unit.

Further, a reserve erase block refers to an erase block that is used for reallocation of a bad erase block. In general, a reserve erase block should be designed to be used only for reallocation of a bad erase block and must not be used as an alternate erase block when an update is made.

Erase blocks are placed in either of two physical states, that is, whether or not data has been written therein. However, they are logically managed in three states: erased→occupied→deallocated (→erased), as shown in FIG. 11.

Here, an erased erase block (state 3001) shown in FIG. 11 refers to an erase block in which all data was initialized to “1”. In a memory card, erased erase blocks are commonly managed in a list structure and used when a new segment is allocated or when existing data is updated.

However, data other than “1” such as a rewrite count may be written in a metadata part. Further, on the assumption that data in a logical address to which an occupied erase block is not allocated comprises “0s”, an occupied erase block containing all segment data happened to be “0” can be taken to be erasable.

An occupied erase block (state 3002) in FIG. 11 refers to an erase block written with data and allocated to a logical address. When data on the memory card is externally overwritten for update, the following manipulation is actually performed: relocating the data existing in the occupied erase block to another erased erase block and adding the occupied erase block to a sequence of deallocated erase blocks.

A deallocated erase block (state 3003) refers to an erase block in which data is written but not allocated to any logical address resulted from overwriting for update to an occupied erase block.

This block is erased by the memory management unit during an idle time and added to a list of erased erase blocks. Exceptionally, an erase block containing all segment data of “0” can be handled as a deallocated erase block (3004) even if it was allocated to a logical address and can be handled to be erasable.

However, in the case of some memory cards encapsulated in a package, it may be impossible to control state change from a general-purpose storage I/O interface for external use. Some memory card products with an extended general-purpose I/O interface may specially have an erase instruction to convey that an erase block is erasable.

In this way, the use of memory cards enables storage manipulation using a commonly used general-purpose storage interface, concealing complexity of management specific to nonvolatile semiconductor memories.

### SUMMARY

However, it was found by the present inventors that the above-described data management technique for a storage device using a nonvolatile semiconductor memory has the following problems.

Since rewritable counts of memory cells and all that cannot be concealed completely, a problem arises even when a memory card is used, if a file system technology or database technology which has been developed for hard disks is applied as is.

When erased erase blocks in a memory card have become fewer, area shrinkage gives rise to problems that the risk of data loss becomes higher and the writing speed decreases significantly.

Here, the area shrinkage refers to a phenomenon in which the physical length of a storage area appears to become smaller when a bad erase block occurs in a condition where there is no reserve erase block in an environment where a memory card is used.

Here, the decrease in the writing speed occurs when data update or insertion is executed in a condition where there is no erased erase block in an environment where a memory card is used. In this case, first, a deallocated erase block must be erased to create an erased erase block and data update or insertion executed to the erased erase block, with the result that the speed decreases.

An object of the present invention is to provide a technique that can prevent data loss and a significant decrease in the writing speed due to area shrinkage even if erased erase blocks become fewer in a storage device such as a memory card.

The above and other objects and novel features of the present invention will be apparent from the following description of the present specification and accompanying drawings.

Typical aspects of the invention disclosed herein are summarized below.

One aspect of the present invention resides in a memory area management method for managing a storage device including a group of memory areas each of which is to be storing data used by an application. Specifically, the method comprises the steps of: if data, in a first memory area among the group of memory areas, is not used by the application, specifying a memory area located at the tail of the group of memory areas, copying, to the first memory area, data in the specified memory area and erasing data which has been stored in the specified memory area. Further the method includes the steps of: setting the specified memory area to a second memory area as memory area where data has been erased, comparing between number of a group of second memory areas and predetermined number of memory areas, allocating a new memory area from the group of the second memory areas to the application, the new memory area is located other than predetermined number of second memory areas from tail of the group of the second areas, if the number of a group of second memory areas are more than predetermined number of memory areas; and, sending, to the application, an instruction indicating that if the number of a group of second memory areas are less than predetermined number of memory areas.

Another aspect of the present invention resides in a memory area management method for data management of a storage device by a logical data management layer including an exclusive control manager. The method comprises the following steps: obtaining an exclusive write control over a data management layer from the exclusive control manager; obtaining a segment management structure for the data management layer; obtaining all memory areas managed by the segment management structure and creating a list of memory areas that are obtainable; determining whether one or more memory areas are not obtainable based on the list; and, if it has been determined that one or more memory areas are not obtainable, reconfiguring the segment management structure based on the list, wherein the memory size of the data management layer is changed when the data management layer is mounted at the first access to the data management layer and when the memory size of the storage device has been changed.

A further aspect of the present invention resides in a memory area management method for data management of a storage device by a logical data management layer including an exclusive control manager. The method comprises the following steps: obtaining an exclusive write control over the last memory segment from the exclusive control manager; obtaining a page management structure for the last memory segment; obtaining all memory areas managed by the page management structure and creating a list of memory areas that are actually obtainable; determining whether one of more memory areas are not obtainable based on the list; if it has been determined that one or more memory areas are not obtainable, reconfiguring the page management structure based on the list; if the page management structure reconfigured does not include any available memory area, obtaining an exclusive write control over the data management layer from the exclusive control manager; obtaining a segment management structure for the data management layer; and removing the segment from the segment management structure, wherein memory size change on the data management layer is processed upon detection of a change in the capacity of the storage device.

Other aspects of the invention disclosed herein are outlined.

Using a natural number n that has previously been defined, it is accomplished to keep the last n erase blocks erased in a virtual storage area of a storage device such as a memory card. However, some types of storage devices may not have an interface for manipulating erase blocks externally. In such case, using a natural number m that is defined to make m memory pages equal in size to n erase blocks, it is accomplished to keep the last m memory pages erased in a file system area or database area and convey that the corresponding erase blocks are erasable to the memory card.

Here, if a natural number p has previously been given, n is set equal to p. Otherwise, a natural number q is used that is defined by a file system processing unit, a database management program, or OS (Operating System) and other middleware, wherein n is set equal to q.

One of the above-identified aspects provides, in a group of memory areas, ensures data of erased memory area has been erased, the erased memory areas that correspond from the tail through a predetermined number of memory areas.

The reliability of a storage device can be improved without deteriorating its performance.

### BRIEF DESCRIPTION OF THE DRAWINGS

FIG. 1 is a block diagram of an information processing system according to a first embodiment of the present invention;

FIG. 2 is a flowchart illustrating an example of a process of allocating a new segment by the information processing system of FIG. 1;

FIG. 3 is a flowchart illustrating an example of a process of deleting a file by the information processing system of FIG. 1;

FIG. 4 is a block diagram showing an example of a configuration of an information processing system according to a second embodiment of the present invention;

FIG. 5 is a flowchart illustrating an example of a process of deleting a file by the information processing system of FIG. 4;

FIG. 6 is a flowchart illustrating an example of a process of erasing a deallocated segment by the information processing system of FIG. 4;

FIG. 7 is a flowchart illustrating an example of a process of reconfiguring file system area metadata by the information processing system according to a third embodiment of the present invention;

FIG. 8 is a flowchart illustrating an example of a process of reconfiguring segment metadata by the information processing system according to the third embodiment of the present invention;

FIG. 9 is a diagram showing the configuration of an information processing system of a first embodiment;

FIG. 10 is a diagram showing the configuration of an information processing system of a second embodiment;

FIG. 11 is a diagram explaining state transition in a nonvolatile semiconductor memory, examined by the present inventors; and

FIG. 12 is a diagram explaining a general concept of an online memory area management method taking account of the occurrence of a bad memory element, examined by the present inventors.

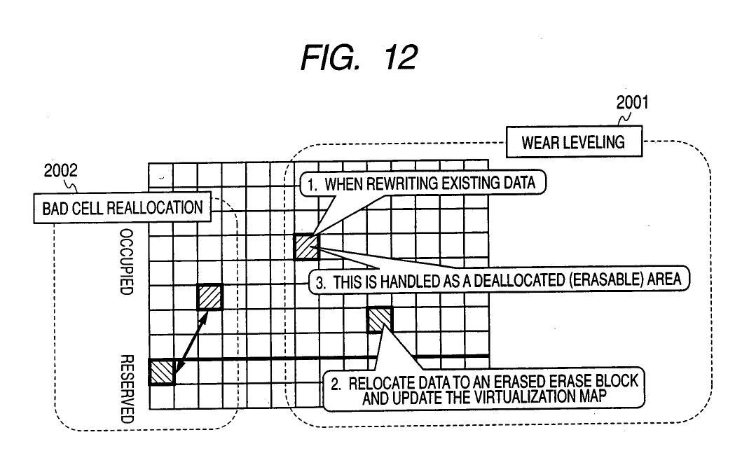

### DETAILED DESCRIPTION OF THE PREFERRED EMBODIMENTS

Embodiments of the present invention will now be described in detail, based on the drawings. In all drawings to explain the embodiments, like components are assigned like reference numerals and their explanation is not repeated.

### First Embodiment

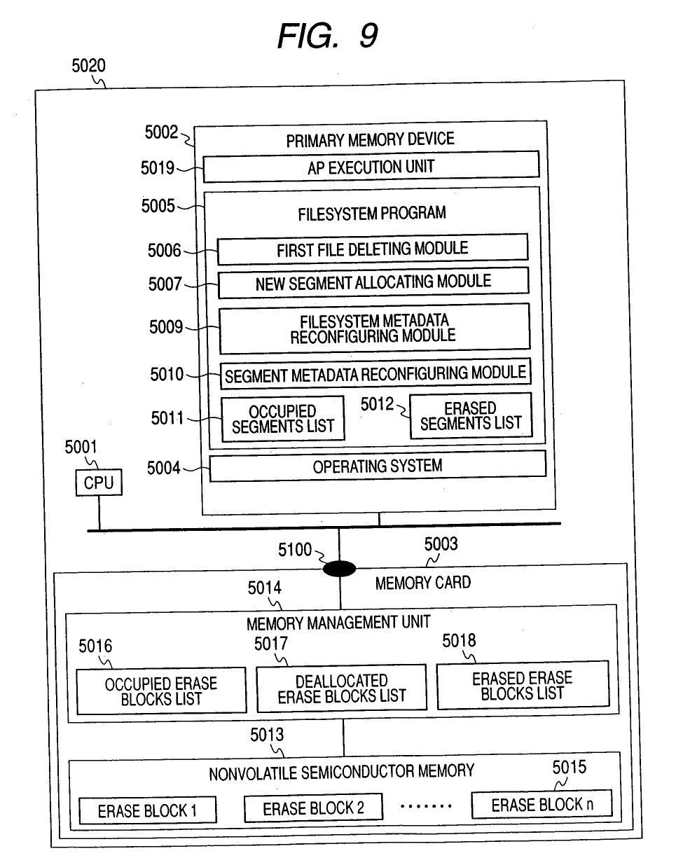

FIG. 9 shows the configuration of an apparatus 5020 that realizes an information processing system of a first embodiment. The apparatus is a computer comprising a CPU 5001, a primary memory device 5002 such as RAM (Random Access Memory), and a memory card 5003 as a secondary memory device. The memory card 5003 is connected to the apparatus via a storage interface 5100.

The CPU 5001 performs management of data on the memory card 5003 by executing an operating system 5004, a file system processing program 5005 on the primary memory device 5002, and an AP execution unit 5019.

The AP execution unit 5019 executes the functions of the information processing system of the present embodiment and hands over a process to the file system processing program 5005 if access to the memory card 5003 is needed.

The file system processing program 5005 comprises a first file deleting module 5006, a new segment allocating module 5007, a deallocated segment erasing module 6008, a file system metadata reconfiguring module 5009, a segment metadata reconfiguring module 5010, an occupied segments list 5011, and an erased segments list 5012.

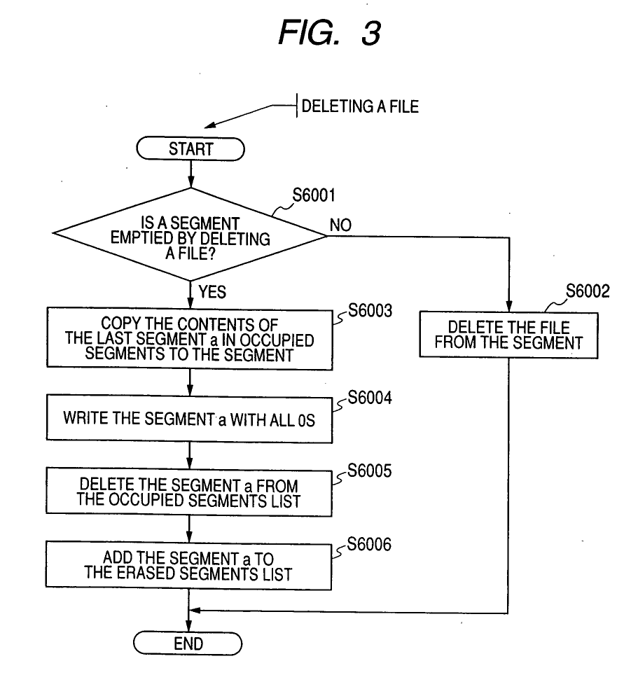

The first file deleting module 5006 executes a process of deleting a file according to a flowchart which is shown in FIG. 3.

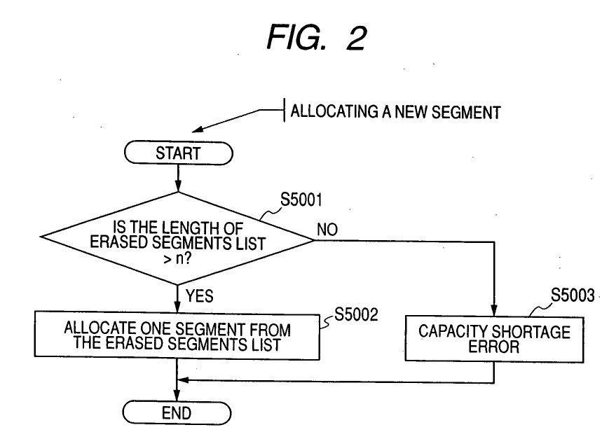

The new segment allocating module 5007 executes a process of allocating a new segment according to a flowchart which is shown in FIG. 2.

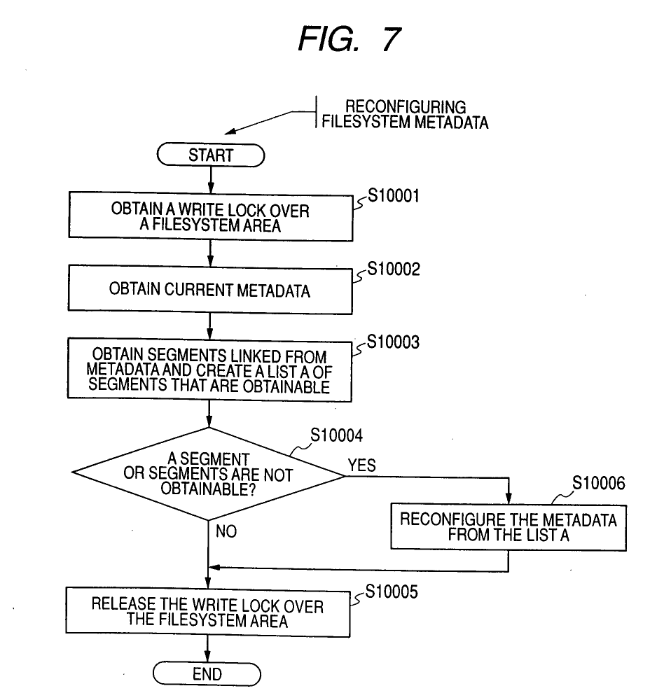

The file system metadata reconfiguring module 5009 executes a process of reconfiguring file system metadata according to a flowchart which is shown in FIG. 7.

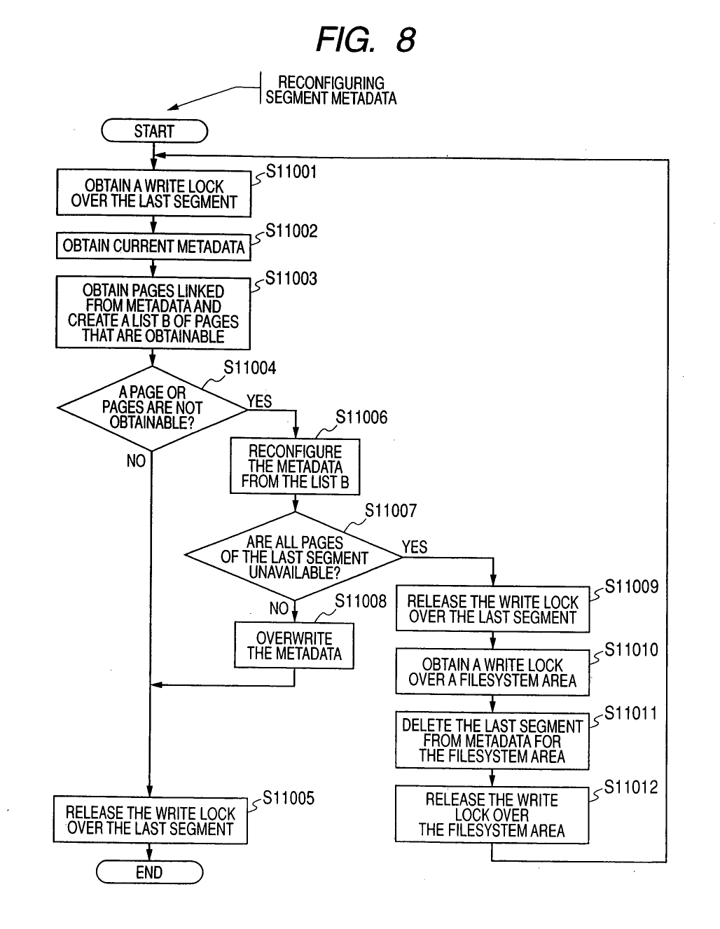

The segment metadata reconfiguring module 5010 executes a process of reconfiguring segment metadata according to a flowchart which is shown in FIG. 8.

The occupied segments list 5011 and erased segments list 5012 are used to manage occupied and erased segment numbers in a list, respectively.

The memory card 5003 comprises a nonvolatile semiconductor memory 5013 and a memory management unit 5014. The nonvolatile semiconductor memory 5013 and the memory management unit 5014 are connected.

The internal space of the nonvolatile semiconductor memory 5013 is divided into n pieces of erase blocks 5015. The erase blocks 5014 are erasable units to be managed in the nonvolatile semiconductor memory 5013 and identified by their unique numbers.

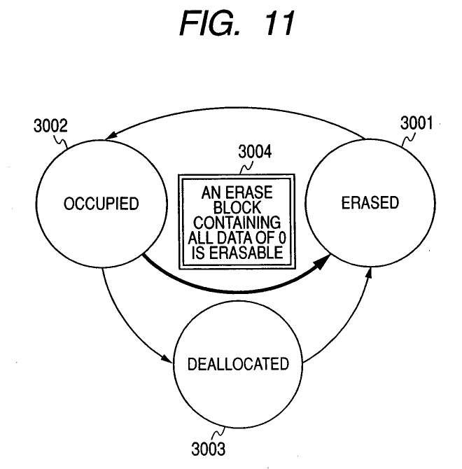

The memory management unit 5014 manages transition of the states of the blocks in the nonvolatile semiconductor memory, shown in FIG. 11, by managing an occupied erase blocks list 5016, a deallocated erase blocks list 5017, and an erased erase blocks list 5018.

The occupied erase blocks list 5016, deallocated erase blocks list 5017, erased erase blocks list 5018 are used to manage the numbers of corresponding erase blocks 5015 in a list, respectively. The memory card 5003 may be external or internal to the apparatus 5020.

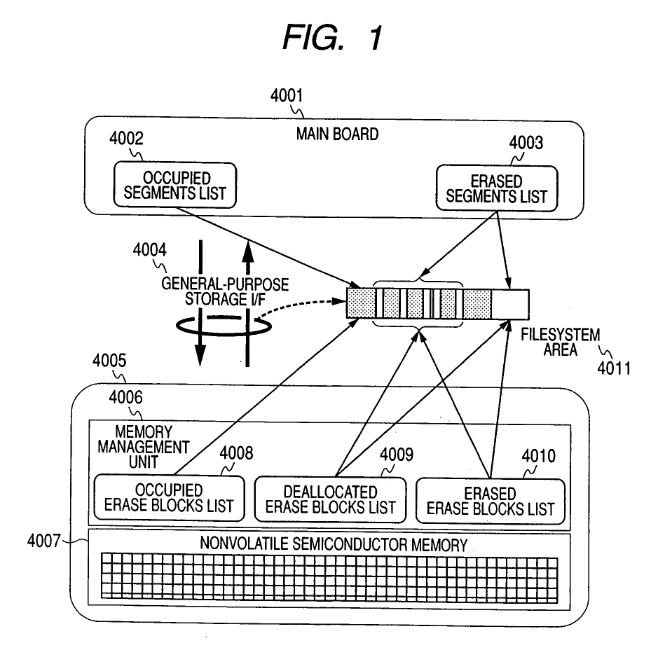

FIG. 1 is a block diagram of an information processing system according to the first embodiment of the present invention. FIG. 2 is a flowchart illustrating an example of the process of allocating a new segment by the information processing system of FIG. 1. FIG. 3 is a flowchart illustrating an example of the process of deleting a file by the information processing system of FIG. 1.

In the first embodiment, the information processing system comprises, for example, a computer system such as a personal computer. In the information processing system, there is a main board 4001 as shown in FIG. 1.

The main board 4001 is a board on which basic electronic parts including memory, CPU, expansion slots, etc. are mounted. A memory card 4005 typified by, for example, an SD (Secure Digital) card is connected to the main board 4001 via a standard general-purpose storage interface 4004 such as, for example, ATA and USB mass storage.

Here, the storage partitions are managed by a file system or a database management system. In general, the file system or database management system manages the storage partitions in units called segments. A segment consists of a plurality of serial pages which are minimum accessible units on the storage.

In the file system or database management system, usually, occupied segments and deallocated segments are managed. The present system is characterized in that erased segments instead of deallocated segments are managed.

An occupied segment is a segment being used to store significant data, whereas an erased segment is not being used to store significant data and is a segment that was erased by writing an erase instruction and data for erasure. A deallocated segment is a segment not being used to store significant data, but it is not included in erased segments, because an erase instruction and data for erasure are not written in it.

Information for management of these occupied, deallocated, and erased segments and other portions of a memory area is all stored in a special location called a segment management structure or super-block within a memory area. The segment management structure is often located near the top of the memory area.

The file system processing unit operating on the main board 4001 performs management of an occupied segments list 4002 which is a list of occupied segments and an erased segments list 4003 which consists of a list of erased segments.

The memory card 4005 serving as a storage device includes a memory management unit 4006 that exerts control of the memory card 4005 and a nonvolatile semiconductor memory 4007 such as, e.g., a flash memory. There is no restriction on the type of the memory card 4005; it may be any type of memory card that is accessible via a standard storage I/O interface such as, for example, ATA (Advanced Technology Attachment) or USB mass storage.

In the memory management unit, an occupied erase blocks list 4008, a deallocated erase blocks list 4009, and an erased erase blocks list 4010 are managed.

Here, erase blocks are minimum units that are erasable in the nonvolatile semiconductor memory 40078. A deallocated erase block is an erase block in which data is written, resulted from overwriting for update to an occupied erase block, but not allocated to any logical address.

Further, an erased erase block is an erase block in which all data was initialized to “1”. An occupied erase block is an erase block in which data was written, allocated to an logical address.

On the storage area provided by the memory card 4005, a file system area 4011 is defined where files which mostly have a size of several Kbytes or more are managed. Data in the file system area 4011 is managed by the above file system processing unit. The memory management unit 4006 has a function that regards an occupied erase block containing all data of “0” as erasable.

Then, a segment management technique by the information processing system of the first embodiment is described.

To begin with, the process of allocating a new segment is explained, using the flowchart of FIG. 2. This process occurs in a situation where a new segment is needed when the AP execution unit 5019 hands over an operation of creating or updating a file to the file system processing program 5005.

When the process of allocating a new segment starts, it is determined whether the length of the erased segments list 4003 is longer than n (a natural number) that has previously been set arbitrarily (step S5001). If the list length is longer, one segment from the erased segments list 4003 is allocated (step S5002) and the process terminates. Otherwise, if the list length is no longer, as determined at step S5001, a capacity shortage error is returned (step S5003) and the process terminates.

Next, the process of deleting a file is explained, using the flowchart of FIG. 3. This process occurs when the AP execution unit 5019 hands over an operation of deleting a file to the file system processing program 5005.

When the process of deleting a file starts, it is determined whether a segment including the file that is now going to be processed will be emptied by deleting the file (step S6001). If not so, the file is deleted from the segment (step S6002) and the process terminates.

A method of deleting a file is to write “0s” in a segment portion actually occupied by the file. Alternatively, segment management data may only be manipulated such that the segment portion occupied by the file is regarded as having no data allocated to it.

Otherwise, if it has been determined that the segment will be emptied at step S6001, the contents of the last segment-a in the occupied segments are copied to that segment (step S6003). Then, the segment-a is written with all “0s” as data for erasure (step S6004).

By this manipulation, any erase block included in the segment-a becomes erasable by the memory management unit 4006. Subsequently, the segment-a is deleted from the occupied segments list 4002 (step S6005), the segment-a is added to the erased segments list 4003 (step S6006), and the process terminates.

Here, if the used memory card 4006 has a block erase instruction, the erase instruction to erase the data in the segment-a is issued to execute step S6004.

When the present embodiment is implemented, if the size of a segment is set equal to or greater than the size of an erase block, it can be ensured that an erase block included in the segment is erased by writing the emptied segment with all “0s” (step S6004).

Accordingly, the first embodiment provides the effect of preventing data loss, even if area shrinkage arises due to bad erase blocks occurring during a write to the nonvolatile semiconductor memory 4007, provided that the number of the bad erase blocks is n or fewer.

Because erased erase blocks are prepared whenever a write operation is performed, it can be prevented that the writing performance deteriorates.

Although the management in units of segments was discussed above, the management may be performed in units of pages for a small size storage in which the number of pages is rather small.

In the latter case, a page management structure is located in a specific location in the memory area to manage occupied, deallocated, and erased pages.

Conceivably, larger manageable units, each consisting of multiple segments, or even larger manageable units may be introduced in future. The present invention is applicable to all such manageable units.

### Second Embodiment

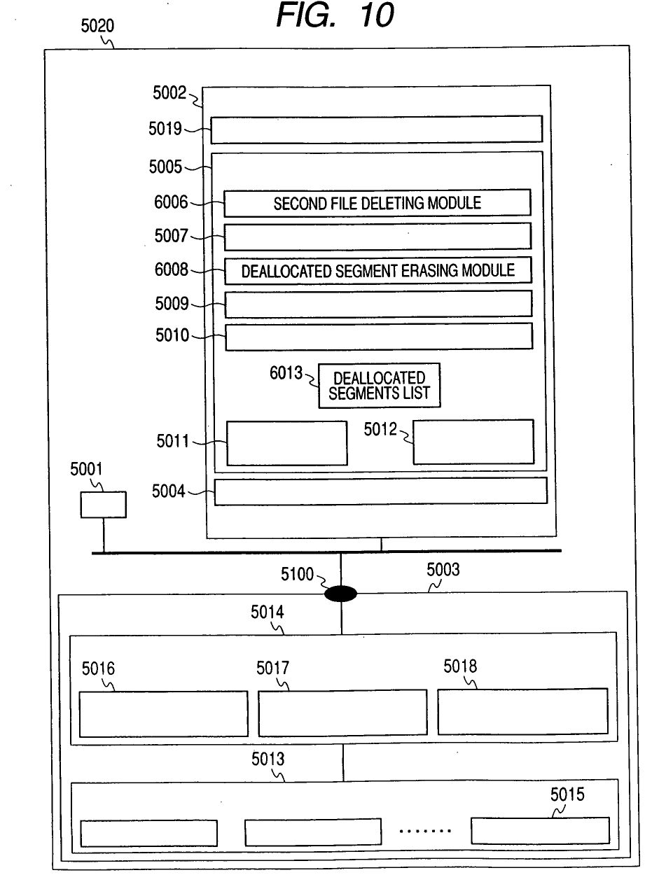

FIG. 10 shows only a part of an apparatus that realizes an information processing system of a second embodiment, the part differing from the apparatus shown in FIG. 9. The apparatus comprises a CPU 5001, a primary memory device 5002 such as RAM, and a memory card 5003 as a secondary memory device.

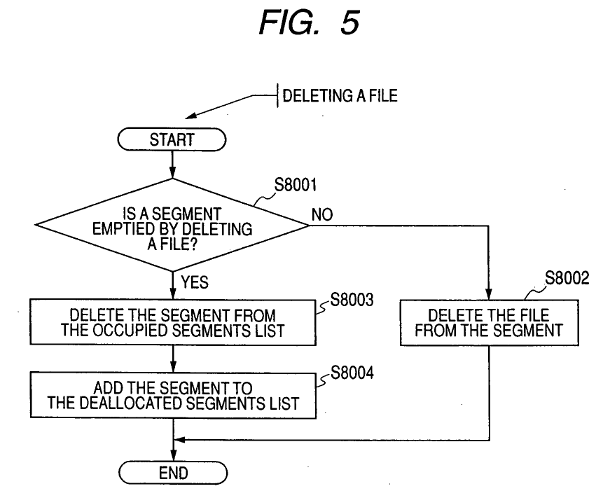

A file system processing program 5005 in this embodiment includes a deallocated segments list 6013. The deallocated segments list 6013 is used to manage deallocated segment numbers in a list. A second file deleting module 6006 executes a process of deleting a file according to a flowchart which is shown in FIG. 5.

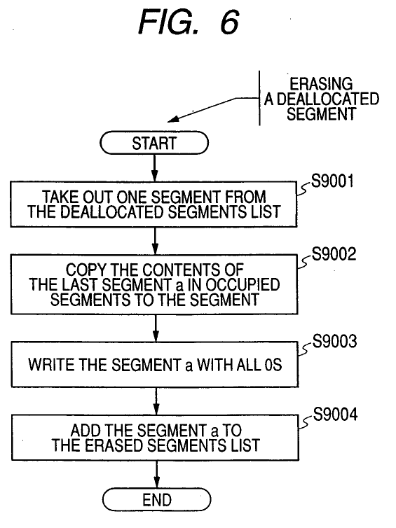

Further, a deallocated segment erasing module 6008 executes a process of erasing a deallocated segment according to a flowchart which is shown in FIG. 6.

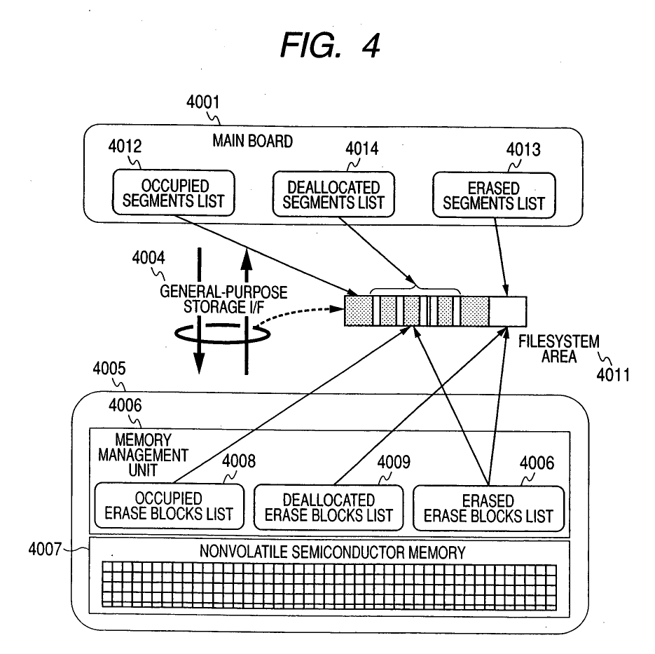

FIG. 4 is a block diagram showing an example of a configuration of the information processing system according to the second embodiment of the present invention. FIG. 5 is a flowchart illustrating an example of the process of deleting a file by the information processing system of FIG. 4. FIG. 6 is a flowchart illustrating an example of the process of erasing a deallocated segment by the information processing system of FIG. 4.

The information processing system of the second embodiment is configured in the same way as in the foregoing first embodiment, as shown in FIG. 4. A difference lies in that the occupied segments list 4012, deallocated segments list 4013, erased segments list 4014 are managed by the file system management unit operating on the main board 4001.

In this case, the information processing system has a management structure consisting of pages and segments on the storage of the memory card 4005.

Here, an occupied segment is being used to store significant data, whereas an erased segment is not being used to store significant data and was erased by writing an erase instruction and data for erasure. A deallocated segment is not being used to store significant data, but it is not included in erased segments.

On the storage area of the memory card 4005, a file system area 4011 is defined as is the case for the foregoing first embodiment. The memory management unit 4008 has a function that regards an occupied erase block containing all data of “0” as erasable.

In the second embodiment as well, the process illustrated in FIG. 2 for the foregoing embodiment 1 is also executed, when a new segment is needed to create or update a file.

On the other hand, a process that should be performed when a file is deleted differs from that in the foregoing first embodiment. This process is carried out according to the flowcharts shown in FIGS. 5 and 6.

First, when the process of deleting a file starts in FIG. 5, it is determined whether a segment including the file that is now going to be processed will be emptied by deleting the file (step S8001). If not so, the file is deleted from the segment (step S8002) and the process terminates.

If it has been determined that the segment will be emptied at step S8001, the segment is deleted from the occupied segments list 4012 (step S8003), the segment is added to the deallocated segments list 4014 (step S8004), and the process terminates.

Subsequently, the segment added to the deallocated segments list 4014 by the process of FIG. 5 is appropriately erased according to the flowchart shown in FIG. 6 and this segment is moved to the erased segments list 4013.

When the process of erasing a deallocated segment starts in FIG. 6, one segment is taken out from the deallocated segments list 4014 (step S9001). The contents of the last segment-a in occupied segments are copied to the segment (step s9002) and the segment-a is written with all “0s” (step S9003). The segment-a is added to the erased segments list 4013 (step S9004) and the process terminates.

The timing to start the process of erasing a deallocated segment illustrated in FIG. 6 may be, for example, on the elapse of a certain period of time during which no processing occurs, when the deallocated segments list 4014 length has exceeded a certain length, and when a capacity shortage error (step S5003 in FIG. 2) occurs during the process of allocating a new segment.

Accordingly, likewise, the second embodiment likewise provides the effect of preventing data loss, even if area shrinkage arises due to bad erase blocks occurring during a write to the nonvolatile semiconductor memory 4007, provided that the number of the bad erase blocks is n or fewer.

Because erased erase blocks are prepared whenever a write operation is performed, it can be prevented that the writing performance deteriorates.

Further, a general process response time can be improved by the management in a manner of exactly separating deallocated segments and erased segments.

For a system that does not have manageable units corresponding to segments, the same effect can be obtained by the management in a manner of separating deallocated pages and erased pages.

### Third Embodiment

FIG. 7 is a flowchart illustrating an example of a process of reconfiguring file system area metadata by the information processing system according to a third embodiment of the present invention. FIG. 8 is a flowchart illustrating an example of a process of reconfiguring segment metadata by the information processing system according to the third embodiment of the present invention.

The third embodiment relates to a technique for coping with storage area shrinkage occurred due to a fault in erase blocks of the nonvolatile semiconductor memory 4007 in the information processing system having the same configuration as in the foregoing first and second embodiments.

A shrinkage of the storage area length may be detected during mounting a file system or writing thereto. In that event, the shrinkage is coped with by executing the process of reconfiguring file system area metadata illustrated in FIG. 7 and then executing the process of reconfiguring segment metadata illustrated in FIG. 8.

First, when the process of reconfiguring file system area metadata starts, an exclusive control manager (not shown) in the file system processing unit obtains an exclusive write permission over a file system area (step S10001) and obtains current metadata (step S10002).

Then, the manager obtains segments liked from the metadata and creates a list A of segments that are obtainable (step S10003). It determines whether a segment or segments are not obtainable (step S10004).

If all segments are obtainable in the step S10003, it can be judged that consistency between the current state of the file system area and the file system area metadata is maintained. Then, the manager releases the exclusive write permission over the file system area (step S10005) and the process terminates.

Otherwise, if some segments are not obtainable in the step S10003, the manager reconfigures metadata from the list A (step S10006).

Subsequently, in the process of reconfiguring segment metadata illustrated in FIG. 8, the manager first obtains an exclusive write permission over the last segment (step S11001), because only the last segment is affected by area shrinkage, and obtains current metadata (step S11002).

Then, the manager obtains pages linked from the metadata and creates a list B of pages that are obtainable (step S11003) It determines whether a page or pages are not obtainable (step S11004).

If all pages are obtainable, it can be judged that consistency between the current state of the segment and the segment metadata is maintained. Then, the manager releases the exclusive write permission over the last segment (step S11005) and the process terminates.

Otherwise, if some pages are not obtainable in the step S11004, the manager reconfigures metadata from the list B (step S11006) and determines whether all pages in the last segment are not available (step S11007).

If not so, the manager overwrites the metadata (step S11008). If so in the step S11007, the manager releases the exclusive write permission over the last segment (step S11009) and obtains an exclusive write permission over a file system area (step S11010).

The manager deletes the last segment from the file system area metadata (step S11011), releases the exclusive write permission over the file system area, and returns to the step S11001 to check whether a fault occurs in the new last segment.

Here, an example of a file system in which the present embodiment is applied is a file system with a hierarchy of pages, segments, and file system areas in ascending order of granularity. Even for a file system and a database management system with a deeper hierarchy, area shrinkage can be coped with by appropriately applying the same procedure repeatedly.

Accordingly, the third embodiment likewise provides the effect of preventing data loss, even if area shrinkage arises due to bad erase blocks occurring during a write to the nonvolatile semiconductor memory 4007, provided that the number of the bad erase blocks is n or fewer.

Because erased erase blocks are prepared whenever a write operation is performed, it can be prevented that the writing performance deteriorates.

The effects that can be provided by a representative of the above described embodiments are summarized below:

(1) Even if area shrinkage arises due to band erase blocks occurring during a write, data loss in the storage device can be prevented.

(2) It can be prevented that the writing performance of the storage device deteriorates.

(3) It is ensured that, in a group of memory areas to be storing data, ensures data of erased memory area has been erased, the erased memory areas that correspond from the tail through a predetermined number of memory areas.

Although the invention made by the present inventors has been described specifically based on its embodiments, it will be appreciated that the present invention is not limited to the foregoing embodiments and may be modified or varied without departing from its gist.

The embodiments disclosed herein are suitable for a technique for managing the storage areas of a storage device such as a memory card in layers of data management.

What is claimed is:

1. A memory area management method for managing a storage device including a group of memory areas each of which is to be storing data used by an application, the method comprising the steps of:
if data, in a first memory area among the group of memory areas, is not used by the application, specifying a memory area located at the tail of the group of memory areas;
copying, to the first memory area, data in the specified memory area and erasing data which has been stored in the specified memory area;
setting the specified memory area to a second memory area as memory area where data has been erased;
comparing between number of a group of second memory areas and predetermined number of memory areas,
allocating a new memory area from the group of the second memory areas to the application, the new memory area is located other than predetermined number of second memory areas from tail of the group of the second areas, if the number of a group of second memory areas are more than predetermined number of memory areas; and,
sending, to the application, an instruction indicating that if the number of a group of second memory areas are less than predetermined number of memory areas.

2. The memory area management method of claim 1, wherein:
the memory areas are managed in units comprising one of the following:
first manageable units of pages which are minimum accessible units in said storage device;
second manageable units of segments, each consisting of a plurality of pages; and
third manageable units in a hierarchy of a plurality of layers of management including the first management layer and the second management layer.

3. The memory area management method of claim 1, wherein:
an erase instruction appropriate for said storage device is issued to erase the contents of a deallocated memory area.

4. The memory area management method of claim 1, wherein:
to erase the contents of a deallocated memory area, the deallocated memory area is written with data for erasure.

5. A memory area management method for data management of a storage device by a logical data management layer including an exclusive control manager, the method comprising the steps of:
obtaining an exclusive write control over a data management layer from said exclusive control manager;
obtaining a page management structure for the data management layer provided with said exclusive write control;
obtaining all memory areas managed by said page management structure and creating a list of memory areas that are obtainable;
determining whether one or more memory areas are not obtainable based on said list; and
if it has been determined that one or more memory areas are not obtainable, reconfiguring said page management structure based on said list,
wherein the memory size of said data management layer is changed when said data management layer is mounted at the first access to said data management layer and when the memory size of said storage device has been changed.

6. The memory area management method of claim 5, wherein:
the memory areas are managed in units comprising one of the following:
first manageable units of pages which are minimum accessible units in said storage device;
second manageable units of segments, each consisting of a plurality of pages; and
third manageable units in a hierarchy of a plurality of layers of management including the first management layer and the second management layer.

7. A memory area management method for data management of a storage device by a logical data management layer including an exclusive control manager, the method comprising the steps of:
obtaining an exclusive write control over the last memory area from said exclusive control manager;
obtaining a page management structure for the memory area provided with said exclusive control;
obtaining all memory areas managed by said page management structure and creating a list of memory areas that are actually obtainable;
determining whether one of more memory areas are not obtainable based on said list;
if it has been determined that one or more memory areas are not obtainable, reconfiguring the page management structure based on said list;
if said page management structure reconfigured does not include any available memory area, obtaining an exclusive write control over the data management layer from said exclusive control manager;
obtaining a segment management structure for the data management layer provided with-said exclusive control; and
obtaining an exclusive write control over the last memory area from said exclusive control manager and removing the segment provided with the exclusive write control from said segment management structure,
wherein memory size change on said data management layer is processed upon detection of a change in the capacity of said storage device.

8. The memory area management method of claim 7, wherein:
the memory areas are managed in units comprising one of the following:
first manageable units of pages which are minimum accessible units in said storage device;
second manageable units of segments, each consisting of a plurality of pages; and
third manageable units in a hierarchy of a plurality of layers of management including the first management layer and the second management layer.

9. A computer comprising:
an interface to be coupled to a storage device including a group of plurality of memory areas each of which stores data used by an application; and,
a main board coupled to the interface;
wherein:
the main board is configured to include a processor for executing an application and a memory coupled to the processor,
if data in a first memory area among the memory areas is not used by the application, the processor specifies a memory area among the group of the memory areas,
copies, to the first memory area, data in the specified memory area, erases data which has been stored in the specified memory area,
sets the specified memory area to a second memory area as memory area where data has been erased,
compares between number of a group of second memory areas and predetermined number of memory areas,
allocates a new memory area from the group of the second memory areas to the application, the new memory area is located other than predetermined number of second memory areas from tail of the group of the second areas, if the number of a group of second memory areas are more than predetermined number of memory areas, and,
sends, to the application, an instruction indicating that if the number of a group of second memory areas are less than predetermined number of memory areas.

10. The computer according to claim 9, wherein:
the memory areas are managed in units comprising one of the following:
first manageable units of pages which are minimum accessible units in said storage device;
second manageable units of segments, each consisting of a plurality of pages; and
third manageable units in a hierarchy of a plurality of layers of management including the first management layer and the second management layer.

11. The computer according to claim 9,
wherein the processor issues, via the external interface, an erase instruction for said storage device to erase the contents of a deallocated memory area.

12. The computer according to claim 9, wherein:
if erasing the contents of a deallocated memory area, the processor issues, via the external interface, an instruction for said storage device to write data for erasure to the deallocated memory area.

13. The computer according to claim 9,
wherein the processor obtains an exclusive write control over a data management layer,
obtains a page management structure for the data management layer provided with said exclusive write control,
obtains all memory areas managed by said page management structure and creates a list of memory areas that are obtainable,
determines whether one or more memory areas are not obtainable based on said list; and
if it has been determined that one or more memory areas are not obtainable, reconfigures said page management structure based on said list,
changes the memory size of said data management layer when said data management layer is mounted at the first access to said data management layer and when the memory size of said storage device has been changed.
